(19) United States
(12) Patent Application Publication
(10) Pub. No.: US 2022/0327459 A1
(43) Pub. Date: Oct. 13, 2022

(54) PERFORMANCE MANAGEMENT BUSINESS METHOD

(71) Applicants: Edgar Quinones, San Juan, PR (US); Eduardo Arroyo, Guaynabo, PR (US)

(72) Inventors: Edgar Quinones, San Juan, PR (US); Eduardo Arroyo, Guaynabo, PR (US)

(21) Appl. No.: 17/711,217

(22) Filed: Apr. 1, 2022

Related U.S. Application Data
(60) Provisional application No. 63/171,601, filed on Apr. 7, 2021.

(51) Int. Cl. G06Q 10/06

(52) U.S. Cl. CPC G06Q 10/06398; G06Q 10/0637; G06Q 10/06393

(57) ABSTRACT

The instant invention relates to a Results and Accountability System Performance Management Business Method that promotes: clarity of expected results, not tasks, from top to bottom of an organization. It is a unique, highly effective, extremely objective, and painless Self-Assessment Performance Management System. It is a purposed driven engagement focused communication; growth and development plan customized specifically for both individuals and processes based on accumulated hard data from historical and tracked results. It provides a consistent, aligned, and individual and organizational systemic results; an engaging work environment for all. It provides an organizational wide structured periodic accountability process that is designed to make the employee control at least 96% of the speaking in the performance review process creating, awareness and introspection and a continuous improvement mindset when implemented.

### CROSS-REFERENCE TO RELATED APPLICATIONS

“This application claims the benefit of U.S. Provisional Patent Application No. 63/171,601, filed on Apr. 7, 2021, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The invention relates to the field of Performance Management Business Method.

### Description of Related Art

Currently the state of the art includes a number of systems both automated and manual to assess employee performance. Companies typically involve numerous stakeholders having interests that may be different but should be aligned for achieving a common objective. Stakeholders can include but are not limited to; Stockholders, Family Council, Board of Directors, CEO, President, Senior Staff, Managers, Supervisors, Team Leaders, Employees, Regulatory Agencies, Suppliers and the end users or customers that demand that the products or services requested be executed and performed fulfilling their needs and expectations. Currently there is enormous subjectivity in the traditional External Judgment Based Performance Evaluation Process.

The various stakeholders associated with an organization may be co-located or geographically dispersed and/or associated with the same or different organizations. The stakeholders may be a homogenous group, or a heterogeneous group composed of governmental entities, for-profit entities, not-for-profit entities, or a combination of the above.

Due to the often complex and distributed nature of modern organizations, there is a need for a consistent assessments system that includes provisions for stakeholders, employees, and management.

In particular there is a need for a solution to at least one of the aforementioned problems. For instance, there is a need for improved performance management assessments.

### BRIEF SUMMARY OF THE INVENTION

The instant invention in one form is directed to a business method which is a Holistic Systemic Result Based Highly Effective and Painless Performance Management System that emphasizes on results and accountability which provides a structured and disciplined method for employees and management. The instant invention provides the user of the system a unique, highly effective, extremely objective, and painless Self-Assessment Performance Management System that is created to promote consistent, aligned, and spectacular individual and organizational systemic results and promote an engaging work environment for all. This is achieved by provoking frequent periodic, guided specific and honest communication, developing continued clear bidirectional expectations while promoting individual introspection, a continuous improvement mindset and structured and disciplined accountability for all results obtained by using the system and methods of the instant invention.

The problem solved by the instant invention is the elimination of subjectivity that is present in the traditional external judgment-based performance evaluation process for all levels within an organization. The instant invention is an objective process which is designed to provoke employee's self-awareness, introspection and accountability of their results using actual results, math, visual aids, tools, technology, and software. The process provides substantial individual execution autonomy while retaining systemic coherence. This is an extremely important characteristic in attracting and retaining top talent, particularly so in millennials and more recent generations and in remote/virtual/hybrid working environments. The instant invention enhances clear accountability in global, virtual, and other physically separate structures and at the same time augments focus and urgency on organizational strategic priorities, an exceptionally large and up to now unsolved challenge.

In a first implementation of the invention, is a manual or computerized system which incorporates management input, employee input and eliminates the subjective nature of performance assessments thereby making the performance assessment process more understandable and easier to implement than existing systems.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is the overall flow chart of the instant invention.

FIG. 2 is a front-end flow chart of the instant invention.

FIG. 3 is an organizational process flow chart of the instant invention.

FIG. 4 is a backend end flow chart of the instant invention.

FIG. 5 shows the main responsibilities screen.

FIG. 6 shows the Performance screen.

FIG. 7 shows the Performance summary screen.

FIG. 8 shows the performance trends screen.

FIG. 9 shows the responsibility detail screen.

FIG. 10 shows the indicator results screen

FIG. 11 shows the result chart screen.

FIG. 12 shows the department results.

FIG. 13 is the required reports compliance register.

FIG. 14 is the required tasks compliance register.

FIG. 15 is the Assigned projects compliance register.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms employee and team member are used interchangeably to mean an individual who works for an organization that is using the instant invention.

The term company and organization as used in the specification is meant to mean either a company or other entity such as a government, or non-government, profit or nonprofit organization.

Prior to a discussion of the preferred embodiment of the invention, it should be understood that while the features and advantages of the invention are illustrated in terms of Performance Indicators and Expectations that the system can be used for any process where individual and organizational performance is evaluated. Performance Indicators are primarily related to Primary Responsibilities but can also be used for, but not limited to, task performance, quality of output, on time results, new client recruitment, response times, service times or any other job-related performance factor.

The current processes used by most organizations to track and rate employee performance include an evaluation process which are highly centered on subjective external performance assessment.

Subjective external performance assessments have fallen short of achieving the goal of substantially improving performance of employees because they are:
highly subjective
focused on the judgment of the one who evaluates, which for many can result in destroying their passion (“engagement”)
is communicated poorly
the process input usually mentally or verbally justifies the reviewers' actions
the process does not force effective, objective, and periodic dialogue the process does not support either individual or process development often resulting in demotivation of both the employee and the supervisor instead of engaging
the process does not promote “accountability”—which is to assume responsibility and be held accountable for the results obtained (good or bad)
the process does not promote systemic integration

The goal of Leadership in any system is to continuously improve the System, the cost effectiveness of all processes, and create and maintain an inspiring and highly engaging work environment for all, promoting the achievement of the organizations Mission, Vision, and desired Organizational Culture/Expected Behaviors.

The instant invention is a Holistic, Systemic, Results Based, Highly Effective and Painless Business Performance Management Method. Is also a unique, highly effective, extremely objective, and painless Self-Assessment Performance Management System that promotes consistent, aligned, and spectacular individual and organizational systemic results and promote an engaging work environment for all. This is achieved by provoking frequent periodic, guided specific and honest communication, developing continued clear bidirectional expectations while promoting individual introspection, a continuous improvement mindset and structured and disciplined accountability for all obtained results.

The current state of the art are evaluation processes centered on subjective external performance assessment.

The subjective external performance assessments have fallen short of achieving the goal of substantially improving performance among other reasons because:
a. They are highly subjective.
b. They are focused on the judgment of the one who evaluates, which for many can result in destroying their passion (“engagement”).
c. They do not create a shared set of criteria to guide the effectiveness of the work process, and a route to improve results in a constructive and non-destructive fashion.
d. They do not promote effective dialog between parties.
e. The employee who receives the input usually mentally or verbally justifies their actions.
f. The process does not support either individual or process development often resulting in demotivation of both the employee and the supervisor instead of engaging
g. The systems do not force effective, objective, and periodic dialogue.
h. The systems do not promote “accountability”—which is to assume responsibility and be held accountable for the results obtained (good or bad).
i. The systems do not promote systemic integration.

Whereas the leadership's role in performance management is to continuously improve the cost effectiveness of all processes in the system and to promote an inspiring work environment for all.

Several elements make this process unique. Several of them are a staple in themselves, weaving a systemic and synergistic process that integrates both the strategic and operational portions of the leadership and management processes in a practical easy to teach and delegate and proven system makes this work unique.

While there are other performance management systems, we know of none of them that come even close to addressing all the following critical factors in a fully holistic and integrated seamless methodology:
1. the vertical strategic organizational coherence
2. a process that catapults objective two-way communications based on data that currently is an aspiration and a challenge for most organizations
3. a practical, adaptable, and thorough process for establishing and documenting Primary Responsibilities and objective Performance Indicators for every possible Job Position in any type of organization
   a. The method and system cumulative available data base counts with Documented Primary Responsibilities for almost 1000 Job Positions and growing daily based on users' input
   b. Includes over 2,000 Performance Indicators with the flexibility of creating your own, and growing daily based on users' input
   c. This combination allows to create or design a Job Position with related Performance Indicators and Minimum Expected Results profile in under 30 minutes
   d. The method fully addresses a very broad range of Critical Responsibilities, including Risk Management, Operational, Administrative, Strategic Project Management, Supervisory, Financial, Asset Protection, Regulatory and Behavioral Primary Responsibilities, among others.
4. a process that at the same time provides and maintains a formal periodic and straightforward process that balances both expectations and autonomy together with objective execution indicators and clear minimum expectations required for all Primary Responsibilities
5. a process that promotes continuous improvement in every aspect of the relationship
6. allows for hybrid work scenarios
7. enhances employee participation and engagement
8. tracks systemic and individual performance results, development, and growth.
9. department aggregate results promote team integration and improvements
10. organizational wide aggregate results provoke interdepartmental communication and horizontal integration as one team/system
11. converts organizational strategies into traceable and executable projects
12. tracks if projected innovative results become a reality or short- and long-term fine tuning and or adjustments of the Strategic Process are required
13. provides individual and departmental measurements of objective behaviors/conducts vs targeted Vision Based Desired Behaviors/Culture
14. maintains and safeguards historic agreements, comments, audit trails, performance improvement plans and execution results
15. provides clear graphic trend comparison vs expectations with algorithmic based comments to promote introspection without external comments or judgements
16. tailored for fast deployment and implementation no matter the organizations size
17. aggregate results generated provide facts for establishing both targeted individual performance coaching and development, all the way up to strategic opportunity areas for the whole organization Strategic Projects and Continuous Improvement Initiatives

The instant invention encompassed by the results and accountability system highly effective and painless performance management business method is a unique and extremely objective self-assessment performance management system that is created to promote consistent, aligned organizational results. This is achieved by provoking frequent periodic, guided specific and honest communications while promoting individual introspection and accountability for all results obtained.

The current evaluation processes are highly centered on subjective external performance assessment. The problem is so widespread that virtually no organization is satisfied with the effectiveness and practicality of the current performance management models or system. The current state of most organizations highlights the problem. Most organizations fall into one of three categories; they have recently changed their performance management system; they are in the process of changing it or they are actively searching for a more effective option. This problem and state of the processes has been the same for at least last 30 years.

Subjective external performance assessments have fallen short of achieving the goal of substantially improving performance among other reasons.

The instant invention comprises the following components:
A module, process and or methodology for management to document the organization's mission.
A module, process and or methodology for management to document the organization's vision.
A module, process and or methodology for management to document the organization's strategic objectives.
A module, process and or methodology for management to document the organization's expected behaviors, specifically selected to support the achievement of the Strategic Objectives and the realization of the Vision, operationalizing the theory that culture follows strategy
A module, process and or methodology for management to document the organization's systemic performance indicators.
A module, process and or methodology for the employee input, review and analysis module.

The key question is how an organization implements the instant invention within an organization.

First, the organizations top management, in coordination with Board of Directors and Stockholders/Family Council, must determine and document the organization's Mission, Vision, Strategic Objectives, Expected Behaviors and Systemic Performance Indicators.
The Mission Statement must be documented as expected results using an extremely specific method; verb, who or what receives the verb and expected results. No more than fifteen words is highly preferred. Key concepts or specific words must be clearly explained to avoid different interpretations of the Mission Statement. Emphasis must be placed on the value that is added by the organization and not on the how it is added. High level Performance Indicators for the Mission Statement must be determined and documented.
The Vision Statement must be identified and documented. No more than 12 extremely specific high-level Vision Results/Strategic Objectives for each entity should be determined and documented. The high-level results for the Vision can be bulleted or paragraphs. The way they are documented should inspire people to want to achieve them. For each extremely specific high-level Vision Results/Strategic Objectives, Performance Indicators must be determined and documented.

For each extremely specific high-level Vision Results/Strategic Objectives a highly detailed specific action plan must be established and documented (Assigned Projects Compliance Register highly recommended)

Organizational Values and Principles must be identified and documented (no more than 12). Each value and/or principle should be operationalized by stating expected observable behaviors for each, so everyone understands what specific behaviors are expected from people that follow those values and principles. Consider having at least two sets of behaviors that reflect the required culture: managers and non-managers. The objective of two sets of behaviors is to have samples that any employee can relate to no matter where they are assigned to work. Emphasis must be placed on assuring that they are correctly documented as behaviors and not values. Performance Indicators must be identified and documented for Expected Behaviors compliance. This solves the eternal conflict of confused expectations at performance evaluation time.

For each Job Position within the organization the following must be addressed.
The high-level contribution to the Mission must be documented as expected results using an extremely specific method; verb, who or what receives the verb and expected results. This process cannot be taken as a simple event, since it starts by landing exactly why, in terms of mission-value based systemic-organization focused perspective, this position is needed.
Primary Responsibilities must be documented as expected results using an extremely specific method; verb, who or what receives the verb and expected results.
To promote effective recruiting and Skill Gap Analysis for each Primary Responsibility documented the essential skills and technical capabilities necessary to fulfill them effectively must be identified and documented.
For the essential skills and technical capabilities necessary to fulfill the Primary Responsibilities an objective manner to evaluate each one must be identified and documented.
For each objective manner to evaluate the skills and technical capabilities the minimum grade required to validate the level of proficiency must be identified and documented. This step is of the utmost importance and should be used to recruit effectively and train when opportunity area identified in Skill Gap Analysis.
Responsibilities should consider for each job. Up to six specific types of responsibilities: Operational, Supervisory, Project Management including Strategic Projects, Financial, Administrative and Behavior. Emphasis must be placed on the value/result that is added by the Responsibility and not on the how it is done. The how is managed through improvement and or accountability sessions.
For each Primary Responsibilities documented Performance Indicators must be identified and documented. Emphasis must be placed on assuring that Performance Indicators objectively measure cost effectiveness and must be under the control or major influence of the Job Position. Performance Indicators should consider the following types of Indicators; Quantitative, Qualitative, Average Time and Efficiency.
For each Performance Indicator identified and documented the minimum performance expectation must be objectively identified and documented. Minimum performance expectations must be fair and obtainable while maintaining a favorable growth-oriented challenge/skill balance
Expectations should consider at least 3 types of expectations; Greater than or Equal to, Equal to and less than or Equal to. (≥, =, ≤)

Data gathering and Analysis when performing an evaluation.

The data used to objectively measure the results per month must be accurate. In order to facilitate this process. The instant invention uses various tools, among others:
a. Required Reports Compliance Register
b. Assigned Projects Compliance Register
c. Required Tasks Compliance Register

Within the instant invention the word Accountable is defined as:
The requirement or obligation of an employee to gather data regarding results obtained, analyze results obtained, compare results obtained vs. minimum required expectations, account for and fully accept responsibility for all results obtained on a periodic basis.

On a Monthly basis the employee is required:
a. to gather accurate and updated data of all the results which correlates to for all Systemic Performance Indicators.
b. enter the data of the results obtained for all indicators in extremely specific tables and graphs.
c. verify if all data is accurate.
d. entering the data of the results obtained for all indicators in extremely specific tables and graphs is fundamental for the individual introspection and reflection process Visual Impact.
e. after data is entered the employee must analyze each graph and determine the level of execution vs the expected results and the indicator trend. VISUAL COMMUNICATION—The process is highly visual, lending to a much higher level of understanding by both supervisor and supervised and promotes a more effective communication and delegation process.
f. for indicators not in compliance the employee must identify, and document suggested corrective actions.
g. Corrective actions must be agreed upon and documented
h. Agreed upon Corrective actions from prior review sessions not executed will result in disciplinary actions.

On a Monthly basis the supervisor is required to:

require that every assigned employee fully and accurately completes the Employee Profile on-time
a. analyze and validate the accuracy of the data.
b. analyze and validate the corrective actions documented by the employee for indicators not in compliance.
c. document all agreements regarding corrective actions.
d. if no corrective actions were identified and documented by the employee for indicators not in compliance the supervisor must ask for actions to improve the non-complying indicators, if no actions are identified the supervisor can suggest improvement ideas.

The Periodic Accountability Process
a. at periodic pre-established intervals, no less than four times a year, the supervisor is required to meet with the employee and establish an employee-lead performance-focused dialogue using the 94/6 model.
b. the supervisor must assure that the employee does the vast majority of the talking during the review process we recommend 94%, this drastically promotes employee's accountability.
c. during the performance focused dialogue, the employee must review all indicators and provide relevant information to further improve performance if needed
d. the supervisor must ask the employee if any further support, training, or assistance is needed to further improve performance.
e. the supervisor must provide recognition when indicators improve or at optimum levels.

The instant invention Performance Management Business Method uses individual and aggregate results information to identify organizational opportunity areas for establishing Individual & Systemic Results Focused Trainings and Continuous Process Improvement Initiatives.

The spirit of continually improving results through directed tangible results oriented initiatives serves as an incredible platform for the development and deployment of LATERAL KNOWLEDGE TRANSFER and BUSINESS INTELLIGENCE initiatives to create aggregate best practices between multiple elements like people with same positions, people with different positions with similar performance indicators, both within a department or organization all the way to between divisions operating independently in different locations throughout the world.

Results and Accountability System Performance Management Business Method is a unique and objective self-assessment performance management system that is created to promote consistent, aligned organizational results. This is achieved by provoking periodic individual introspection and accountability for all results obtained from both management and the employee or team member.

Leadership's role in Performance Management is to continuously improve the cost effectiveness of all processes in the system and to promote an inspiring work environment for all.

As noted, several elements make this process unique. Several of them are a staple in themselves, weaving a systemic and synergistic process that integrates both the strategic and operational portions of the leadership and management processes in a practical easy to teach and delegate and proven system makes this work unique.

The instant invention has improved on this system, and it requires a conscious decision and input from both management and the employee.

Unique features of the instant invention are:
The instant invention addresses the enormous subjectivity in the traditional External Judgment Based Performance Evaluation Process for all organizational levels. The objective Process can stimulate the employee's self-awareness, introspection and accountability of their results using actual results, math, and visual aids. All existing systems are subjective and focused on the judgment of the one who evaluates, which for many can result in destroying their passion (“engagement”) of the employee. In addition, the organizations do not effectively train the supervisors so that they understand the goals and objectives of the organization and have not mastered the skill of effective dialogue.
The instant invention Business Model creates a shared set of criteria to guide the effectiveness of the work process, and a route to improve results in a constructive, non-destructive fashion.

The result is that the employee that receives performance input usually mentally or verbally justify their actions and noncompliance with expected results. The traditional Performance Evaluation Processes do not force effective, objective, and periodic dialogue and does not promote real “accountability” which is to assume responsibility and be held accountable for the results obtained (good or bad) and do not promote Mission, Vision, and Systemic integration.

Critical features on the instant invention that makes it attractive to the user include the method of clarifying expected results for all Primary Responsibilities that must be documented as expected results using an extremely specific method; verb, who or what receives the verb and expected results. Being able to establish fair, just, and controllable Indicators and minimum expectations that promote the employee or individuals understanding of results achieved aligned to all Primary Responsibilities assigned. The periodic review process that almost completely inverts the focus from the supervisor to the employee. And the benefit of having access to aggregate organizational data that inspires the spirit of continually improving results through directed tangible results oriented initiatives that serve as an incredible platform for the development and deployment of LATERAL KNOWLEDGE TRANSFER and BUSINESS INTELLIGENCE initiatives to create aggregate best practices between multiple elements like people with same positions, people with different positions with similar performance indicators, both within a department or organization all the way to between divisions operating independently in different locations throughout the world.

The instant invention proprietary Aggregate Data collected from all Customer Organizations is used to analyze and or experiment with positive and negative pattern correlations between methods and practices with both positive and negative results in order to create and commercialize both developed knowledge and data trends based forecast scenarios for both customers and/or industries developed as a result of Artificial Intelligence (AI) and data science application to all markets including and not limited to Profit, Non Profit, Government and Academic Organizations, Users and our own Research and Publications

Key Concepts and Requirements for optimized implementation include organizational input, management input and a system that allows input for the employee.

The instant invention requires that the organization top management must determine and document the organization's Mission, Vision, Strategic Objectives, Expected Behaviors and Systemic Performance Indicators.

The Mission Statement must be documented as expected results using an extremely specific method; verb, who or what receives the verb and expected results. A Mission Statement containing no more than fifteen words is preferred. Key concepts or specific words must be clearly explained to avoid different interpretations of the Mission Statement. Emphasis must be placed on the value that is added by the organization and not on the how it is added. High level Performance Indicators for the Mission Statement must be determined and documented.

The Vision Statement must be identified and documented. A Vision Statement containing no more than fifteen words is preferred. It must be extremely specific high-level. Specific Vision Results/Strategic Objectives for each entity/employee should be determined and documented. The high-level results for the Vision statement can be bulleted or paragraphs. The documentation must be targeted to inspire people to want to achieve them. For each extremely specific high-level Vision Results/Strategic Objectives, Performance Indicators must be determined and documented.

For each extremely specific high-level Vision Results/Strategic Objectives a highly detailed specific action plan must be established and documented (Assigned Projects Compliance Register). The clarity of the documentation is important to the results and the ability to provide all users with a clear understanding of the Vision and Mission.

Organizational Values and Principles must be identified and documented. The system is flexible, but it is recommended that no more than twelve be defined. Each value and/or principle should be operationalized by stating expected observable behaviors for each, so everyone understands what specific behaviors are expected from people that follow those values and principles. Consider having at least two sets of behaviors that reflect the required culture: managers and non-managers. The intent is to not provide a mechanism where there are two rulers, but for having samples that any employee can relate to no matter where they are assigned to work.

The instant invention emphasis is placed on assuring that they are correctly documented as behaviors and not values. Performance Indicators must be identified and documented for Expected Behaviors compliance. This solves the eternal conflict of confused expectations at performance evaluation time.

For each Job Position the instant invention documents the high-level contribution of each job with respect to the Mission. The high-level contribution must be documented as expected results using an extremely specific method; verb, who or what receives the verb and expected results. This process cannot be taken as a simple event, since it starts by landing exactly why, in terms of mission-value based systemic-organization focused perspective, this position is needed.

The instant invention documents Primary Responsibilities must be documented as expected results using an extremely specific method; verb, who or what receives the verb and expected results.

The instant invention promotes effective recruiting and Skill Gap Analysis for each Primary Responsibility. The instant invention documents the essential skills and technical capabilities necessary to fulfill them effectively must be identified and documented.

The instant invention documents the essential skills and technical capabilities necessary to fulfill the Primary Responsibilities an objective manner to evaluate each one must be identified and documented.

The instant invention documents each objective manner to evaluate the skills and technical capabilities the minimum grade required to validate the level of proficiency must be identified and documented. This step is of the utmost importance and should be used to recruit effectively and train when opportunity areas are identified in Skill Gap Analysis

With respect to Responsibilities the instant invention provides the method of documenting various specific types of responsibilities, but not limited to: Operational, Supervisory, Project Management including Strategic Projects, Financial, Administrative and Behavior. Emphasis must be placed on the value/result that is added by the Responsibility and not on the how it is done. The how is managed through improvement and or accountability sessions.

For each Primary Responsibilities, the instant invention provides the method of documenting Performance Indicators. Performance Indicators must be identified and documented. Emphasis must be placed on assuring that Performance Indicators objectively measure cost effectiveness and must be under the control or major influence of the Job Position.

Performance Indicators should consider the following types of Indicators; Quantitative, Qualitative, Average Time and Efficiency.

For each Performance Indicator identified and documented the minimum performance expectation must be objectively identified and documented. Minimum performance expectations must be fair and obtainable while maintaining a favorable growth-oriented challenge/skill balance

Expectations should consider at least 3 types of expectations; Greater than or Equal to, Equal to and less than or Equal to. (≥, =, ≤)

The instant invention provides Data gathering and Analysis.

The data used by the instant invention to objectively measure the results per month must be accurate. In order to facilitate this process, the system use various tools, among others.
Required Reports Compliance Register
Assigned Projects Compliance Register
Required Tasks Compliance Register

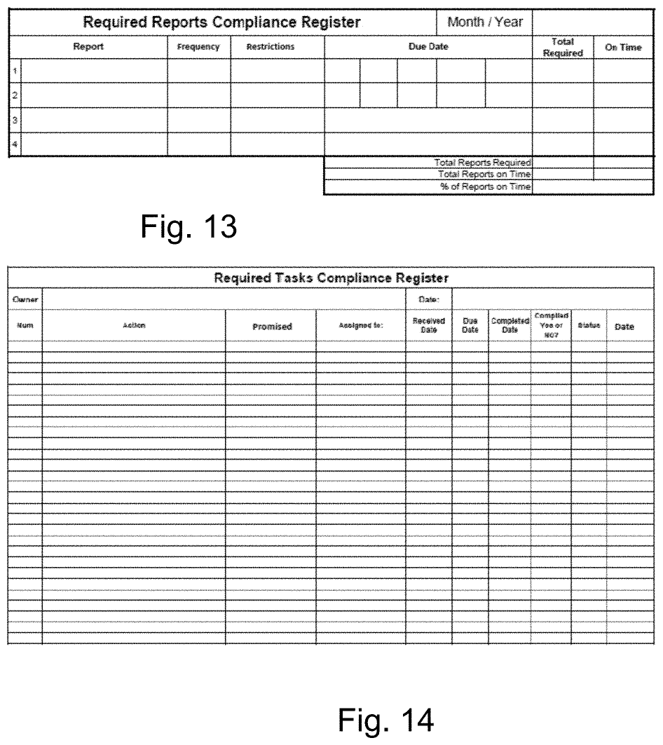

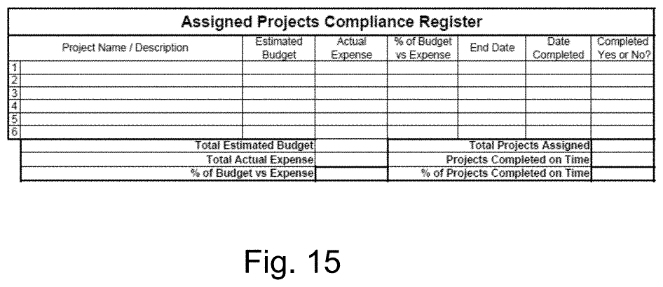

Examples of the data collection method used by the instant invention are shown in FIG. 13, FIG. 14 and FIG. 15. FIG. 13 is the required reports compliance register which list the report require, frequency and restrictions including due dates. FIG. 14 is the required tasks compliance register. FIG. 14 list the actions and who the problem to be solved is assigned to and the completion metrics. FIG. 15 is the Assigned projects compliance register which list the project, budget and performance metrics.

The performance review process of the instant invention. The process of the instant invention makes the employee truly accountable.

With respect to the disclosure and the instant invention the term accountable is defined as:

The requirement or obligation of an employee to gather data regarding results obtained, analyze results obtained, compare results obtained vs. minimum required expectations, account for and fully accept responsibility for all results obtained on a periodic basis.

On a monthly basis the employee is required to use the instant invention to:
Gather accurate and updated data of all the results obtained for all indicators.
Enter the data of the results obtained for all indicators in extremely specific tables and graphs.
Verify if all data is accurate.
Entering the data of the results obtained for all indicators in extremely specific tables and graphs is fundamental for the individual introspection and reflection process.
   The instant invention provides the employee with a method to track performance and utilizes a visual impact presentation means to convey the results. The system utilizes the GPS or IPS location to provide the system with location information for the employee so that the employee is associated with the correct work location or division. This provides the system the ability to aggregate employees and pair their results to the applicable goals.

After the data is entered into the instant invention the employee must analyze each graph and determine the level of execution vs. the expected results where the instant invention provides an indicator trend. The instant invention promotes visual communication which is the process where information is translated into a highly visual display, lending to a much higher level of understanding by both supervisor and the supervised/employee. Visual communication of data promotes a more effective communication and delegation process.

The instant invention highlights those indicators not in compliance and the employee must identify and document suggested corrective actions.

The instant invention formalizes the corrective actions which must be agreed upon and documented.

The instant invention can also provide a method to track agreed upon corrective actions from prior review sessions that were not executed. The system provides the method to document and convey any disciplinary actions due to noncompliance.

The instant invention forces compliance. On a monthly basis the supervisor is required to:
Require that every assigned employee fully and accurately completes the Employee Profile on-time.
Analyze and validate the accuracy of the data.
Analyze and validate the corrective actions documented by the employee for indicators not in compliance.
Document all agreements regarding corrective actions.
If no corrective actions were identified and documented by the employee for indicators not in compliance the supervisor must ask for possible actions to improve the non-complying indicators, if no actions are identified the supervisor can suggest improvement ideas.

The instant invention has a periodic accountability process.

At periodic pre-established intervals, no less than four times a year, the supervisor is required to meet with the employee and establish an employee-lead performance-focused dialogue using the instant invention.

The supervisor must assure that the employee actively participates in the process and must do the majority of the talking during the review process. A good target is for the employee to provide at least 94% of the verbal communication during the session. This level of participation promotes employee's accountability. The agreements and commitments product of the performance review session is documented in the system.

During the performance focused dialogue, the employee must review all indicators and provide relevant information to further improve performance if needed which is documented in the system.

The supervisor must ask the employee if any further support, training, or assistance is needed to further improve performance which is documented in the system.

The supervisor must provide recognition when indicators improve or at optimum levels which is documented in the system.

The instant invention performance management business method uses individual and aggregate results information to identify organizational opportunity areas for establishing individual & systemic results focused trainings and continuous process improvement initiatives.

The spirit of continually improving results through directed tangible results oriented initiatives serves as an incredible platform for the development and deployment of lateral knowledge transfer and business intelligence initiatives to create aggregate best practices between multiple elements like people with same positions, people with different positions with similar performance indicators, both within a department or organization all the way to between divisions operating independently in different locations throughout the world.

The instant invention web-based software presents data to be used solely by the interpretation of the end user and or management, with the intent to improve individual and collective performance.

The instant invention web-based application designed to automate the performance management business method of the instant invention and provides unique tools and functionalities that facilitate and enhance, objective self-assessment and supervisory tasks required to promote consistent, aligned, and organizational results.

Some of the applications benefits among others:
No knowledge of excel required. The system automates all the data entry capture and conversion.
The instant invention updates the graphs manually from month to month.
The instant invention allows the supervisor and employee to see individual results summarized monthly or as needed.
The instant invention allows supervisor and employee to see your individual results in a summary form accumulated per year.
The instant invention allows supervisor and employee to see the results of your individual employees monthly.
Allows supervisor to see the results of their individual employees cumulatively per year.
Allows supervisor to see your department's aggregated results.
The instant invention calculates performance and analyzes monthly conditions.
Currently the instant invention provides automatically computer created action-oriented notifications using our business model specific agreed upon expectations-based algorithms to promote employee introspection and a clearer self-understanding of results vs expectations and performance execution trends. Some of the action-oriented notifications, but not limited to are:
   i. In Compliance and in Optimal Condition.
   ii. In Compliance and Exceeding Expectations.
   iii. In Compliance Exceeding Expectations and In Optimal Condition.
   iv. In Compliance Exceeding Expectations and has an Improving Trend.
   v. In Compliance Exceeding Expectations and has No Change in Trend.
   vi. In Compliance Exceeding Expectations, But Trend is Decreasing/Getting Worse.
   vii. In Compliance and has an Improving Trend.
   viii. In Compliance and has No Change in Trend.
   ix. In Compliance, But Trend is Decreasing/Getting Worse.
   x. Not In Compliance but shows a tendency to improve.
   xi. Not In Compliance and has No Change in Trend.
   xii. Not In Compliance and Trend is Decreasing/Getting Worse.
The instant invention sends supervisor data status notifications, but not limited to are:
   Primary Responsibilities created and pending approval.
   Performance Indicators and expectations created and pending approval.
   Monthly results data entered and pending approval
   Revision meeting reminders, among others.
The instant invention provides a clear generated traceable method to document performance review sessions, which includes but not limited to:
   i. Results obtained,
   ii. Agreements and Commitments.
      1. Document actions in a computer generated and tracked formal follow up process.
   iii. Recognitions.
   iv. Both formal and informal disciplinary actions as validated and framed by users own legal counsel.
      Automatically informs any of the above to relevant parties as established or required.

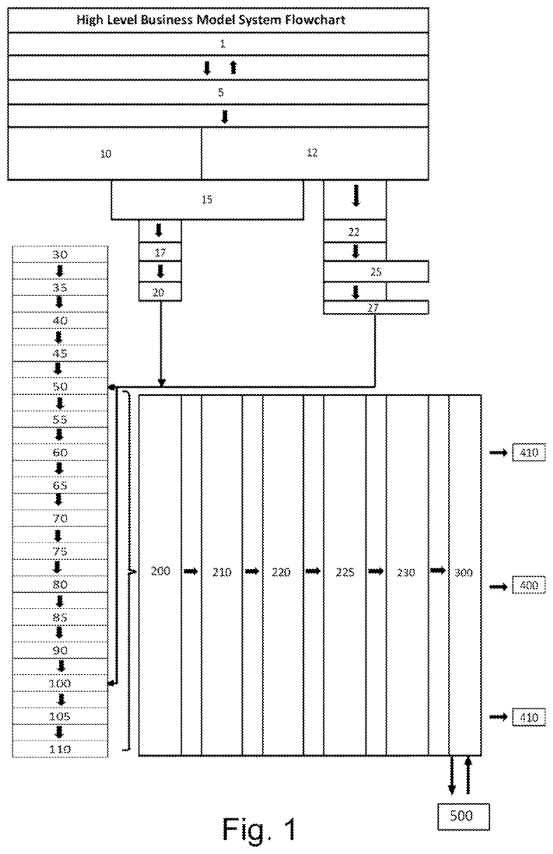

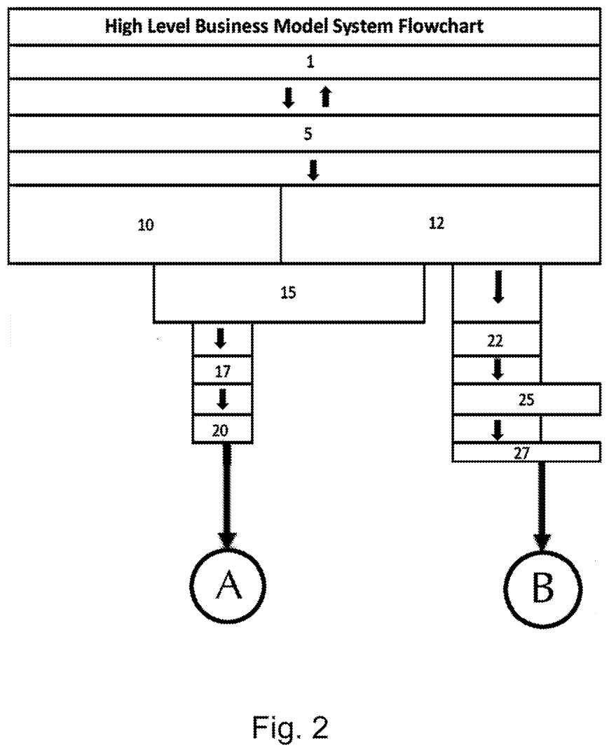

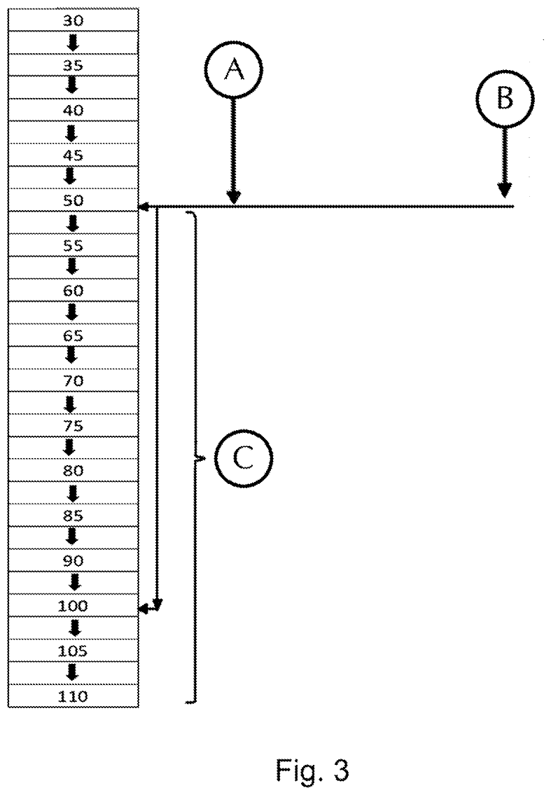

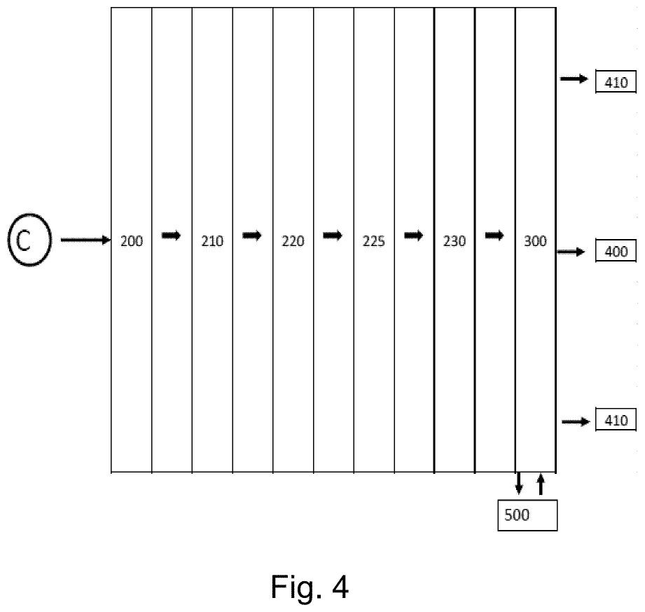

Referring now to the drawings FIGS. 1, 2, 3 and, 4 there is shown a flow chart of the instant invention. The system can use an automated or a manual process. The management of the organization inputs the organizational mission identified and documented using the methodology step 10 and the organizational vision identified & documented (no more than 12 extremely specific high-level vision expected strategic objectives results step 12.

The next step the organization inputs the organizational values and principles that promote the fulfilment of the organizations mission & vision must be identified, documented and operationalized by stating expected observable behaviors for each (no more than 12 for at least 2 levels) step 15 when steps 10 and 12 have been completed. The system captures the ISP and or Email and or GPS location of the management and records it to the instant invention and pairs it with the site so that the correct site information is used in setting up both mission and vision as well as the management employees' information.

The management using the instant invention informs all the employees of the organizational values and principles and organizations mission and vision in step 17 through the use of the instant invention.

The management then using the instant invention assigns to all responsibilities to all levels minimum step 20. There must be at least 2 levels in the organization to utilize the instant invention. The instant invention then passes the control to step 50.

After step 12 is completed then the management adds the strategic focus areas identified & documented in step 22.

The management using the instant invention documents the strategic initiatives and minimum expected results for strategic focus areas identified & documented step 25. These are assigned to the appropriate manager in step 27. The instant invention then passes the control to step 50.

Once step 27 and step 20 are completed then the instant invention has control of the process at step 50 and step 100.

Step 30 of the instant invention the core organizational processes required to fulfill the mission are identified & documented and loads the information into the instant invention.

Step 35 of the instant invention the core organizational processes expected results, performance indicators and minimum levels of expected execution identified & documented by department or process (by process highly recommended) and loads the information into the instant invention.

Step 40 of the instant invention the skills and competencies necessary to effectively achieve the core organizational processes expected results identified & documented and loads the information into the instant invention.

Step 45 of the instant invention recruitment effectively executed to obtain the candidate with the skills and competencies necessary to effectively achieve the core organizational processes expected results and loads the information into the instant invention.

Step 50 of the instant invention receives information from steps 27 and 20. The instant invention then assigns primary responsibilities to managers for all core organizational processes and loads the information into the instant invention. The system captures the ISP and or Email and or GPS location of the management and records it to the instant invention and pairs it with the site so that the correct site information is used in setting up both mission and vision as well as the management employees' information.

The ISP and or Email and or GPS related information ensures that the manager is associated with the correct location of the facility and that the correct goals and visions are also associated with the manager and the employees. The system has a table of ISP and or Email and or GPS locations versus facility or department which is used to confirm the data entry of the location information entered by the management and the employee. Therefore, the data is verified so that it is correct and proper goals are set.

Step 55 of the instant invention receives information from step 50 and the manager reviews primary responsibilities, performance indicators and minimum levels of expected execution and negotiates corrective actions if necessary and loads the information into the instant invention.

Step 60 of the instant invention receives information from step 55 and the manager adds primary responsibilities using the “VWWER” methodology and performance indicators if necessary to better understand the level of execution and loads the information into the instant invention. The VWWER: Verb—Who or What—Expected Results.

Step 65 of the instant invention receives information from step 60 and manager gets approval of added performance indicators if applicable to synchronize and assure unity of purpose and loads the information into the instant invention.

Step 70 of the instant invention receives information from step 65 and manager assigns primary responsibilities to supervisors if applicable and loads the information into the instant invention.

Step 75 of the instant invention receives information from step 70 and supervisor reviews primary responsibilities, performance indicators and minimum levels of expected execution and negotiates corrective actions if necessary and loads the information into the instant invention.

Step 80 of the instant invention receives information from step 75 and Supervisor adds Primary Responsibilities using the “VWWER” Methodology and Performance Indicators if Necessary to better understand the level of execution and loads the information into the instant invention. The VWWER*Verb—Who or What—Expected Results.

Step 85 of the instant invention receives information from step 80 and supervisor gets approval of added performance indicators by supervisor if applicable to synchronize and assure unity of purpose and loads the information into the instant invention.

Step 90 of the instant invention receives information from step 85 and supervisor assigns primary responsibilities to employees if applicable and loads the information into the instant invention.

Step 100 of the instant invention receives information from step 90 and employee reviews primary responsibilities, performance indicators and minimum levels of expected execution and negotiates corrective actions if necessary and loads the information into the instant invention.

Step 105 of the instant invention receives information from step 100 and employee adds performance indicators if necessary to better understand the level of execution and loads the information into the instant invention.

Step 110 of the instant invention receives information from step 105 and employee gets approval of added performance indicators by supervisor if applicable to synchronize and assure unity of purpose and loads the information into the instant invention.

The information gathered and recorded during steps 50 to 110 is passed to step 200 where the employee is empowered, and execution of the performance and corrective actions is permitted.

Step 210 pre-established periodic system objectives self-evaluation process are recorded (up to six levels of responsibilities) are documented in the instant invention.

Step 220 recognition and or improvement process (recognitions and improvement commitments documented in the instant invention).

Step 225 commitments follow up in next pre-established periodic objective self-evaluation process (up to six levels of responsibilities) are documented in the instant invention.

Step 230 execution consequences with predictability and respect (recognitions, disciplinary actions, and transfers if applicable) are documented in the instant invention.

Step 300 is the use of artificial intelligence aided pattern recognition and or improvement opportunities in process and systemic effectiveness, leadership effectiveness and strategic effectiveness. This utilizes step 500 which utilizes the instant invention proprietary aggregate data collected from all customer organizations used to analyze and or experiment with positive and negative pattern correlations between methods and practices with both positive and negative results in order to create and commercialize both developed knowledge and data trends based forecast scenarios for both customers and/or industries developed as a result of historical correlations and/or artificial intelligence (AI), business intelligence based business knowledge, and data science application to all markets including and not limited to profit, non-profit, government and academic organizations, users and our the instant invention research and publications.

Step 410 the instant invention using Business Intelligence provides relevant and result hard data-based facts for producing an organizational development plan.

Step 400 the instant invention using Business Intelligence provides relevant and result hard data-based facts for producing process development plans.

Step 420 the instant invention using Business Intelligence provides relevant and result hard data-based facts for producing individual development plans.

The instant invention can be summarized as a Performance Management Business Method comprising of the steps:

An at least one manager documents an organization's mission.

The at least one manager documents an organization's vision.

The at least one manager documents an organization's strategic objectives.

The at least one manager documents an organization's expected behaviors.

The at least one manager documents an organization's Systemic Performance Indicators.

The at least one manager conveys the organizations mission, the organizations vision, the organizations Strategic Objectives, the organizations expected behaviors, the organizations Systemic Performance Indicators to an at least one employee.

The at least one employee assembles data which correlates to the Systemic Performance Indicators.

The at least one employee provides input for the Systemic Performance Indicators and documents the at least one employee input.

The at least one employee reviews the Systemic Performance Indicators, analyzes the Systemic Performance Indicators, and documents the review of the Systemic Performance Indicators.

The at least one employee identifies, and documents suggested corrective actions for the Systemic Performance Indicators that are not in compliance with agreed to the Systemic Performance Indicators.

The at least one manager and the at least one employee meet at a meeting to review the Systemic Performance Indicators.

The at least one manager and the at least one employee agreed upon and documented the Systemic Performance Indicators results and corrective actions for the Systemic Performance Indicators at the meeting.

The at least one manager and the at least one employee meet at a next meeting and review the Systemic Performance Indicators results and corrective actions for the Systemic Performance Indicators.

The at least one manager and the at least one employee agreed upon and documented the Systemic Performance Indicators results and agreed upon corrective actions for the Systemic Performance Indicators at the next meeting.

At the next meeting the agreed upon corrective actions from prior review sessions not executed will result in disciplinary actions.

The instant invention using Business Intelligence provides relevant and result hard data-based facts for producing an Organizational Development Plan.

The instant invention using Business Intelligence provides relevant and result hard data-based facts for producing Processes Development Plans; and

The instant invention using Business Intelligence provides relevant and result hard data-based facts for producing Individual Development Plans.

The instant invention can be further be summarized as a Performance Management Business Method that is performed using a supervisory computer system comprising of the steps:

The supervisory computer system being connected to at least one management computer with the management application and at least one employee computer with the employee application.

The supervisory computer having at least one known location associated with an ISP and or Email and or GPS location and the supervisory computer having a supervisory computer database that stores at least one known location data at least one manager data and at least one employee data.

The at least one management computer having a management ISP and or Email and or GPS module and at least one employee computer having an employee ISP and or Email and or GPS module.

The at least one management computer sends or records the ISP and or Email and or GPS location of the at least one management computer to the supervisory computer system and the supervisory computer system the ISP and or Email and or GPS location of the at least one management computer to determine at least one known location and the supervisory computer database stores the at least one known location data with the at least one manager data

Management using the at least one management computer system with the management application documents an organization's mission on the at least one management computer system.

Management using the at least one management computer system with the management application documents the organization's Vision.

Management using the at least one management computer system with the management application documents the organization's strategic objectives.

Management using the at least one management computer system with the management application documents the organization's expected behaviors.

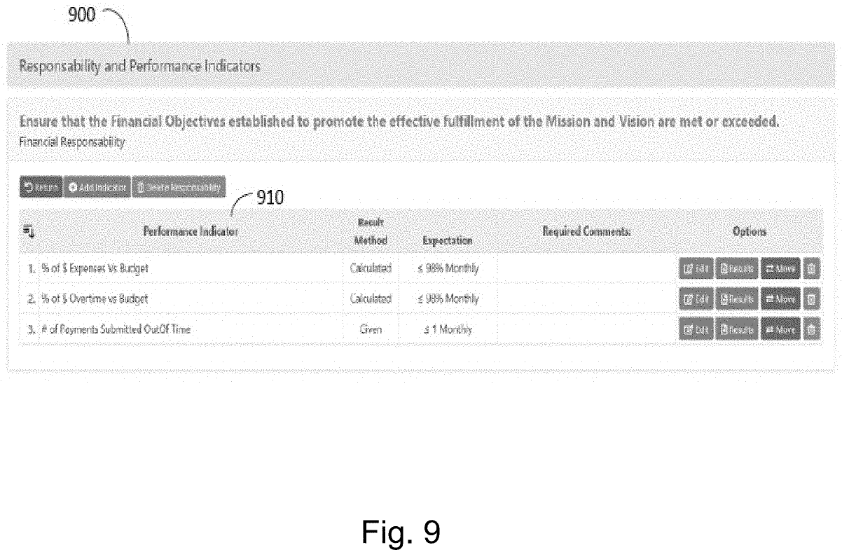

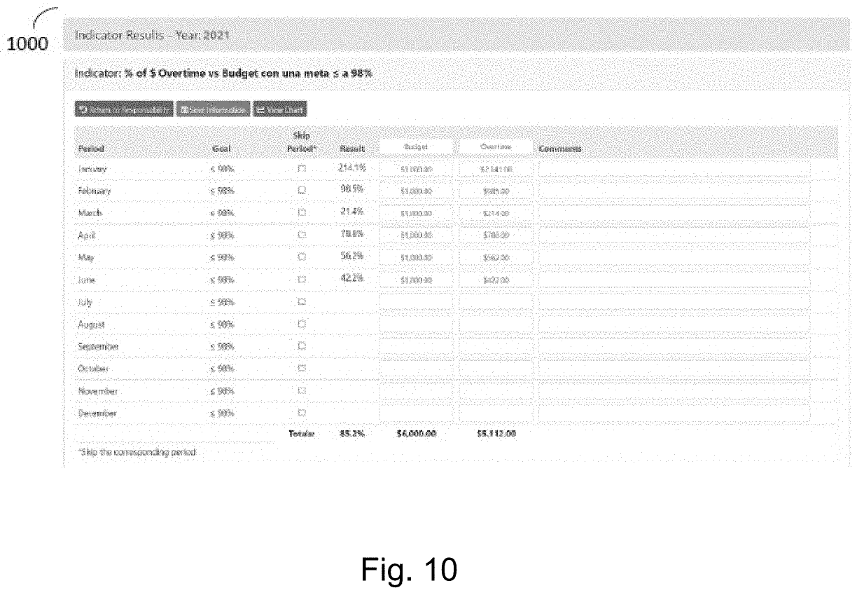

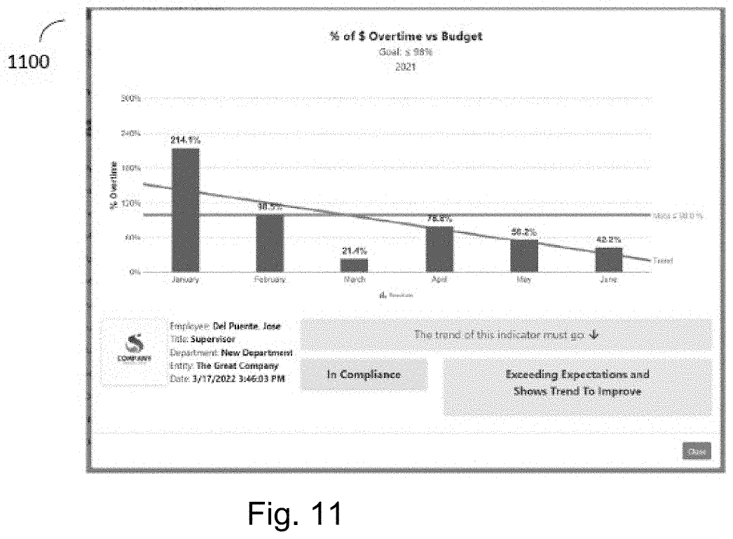

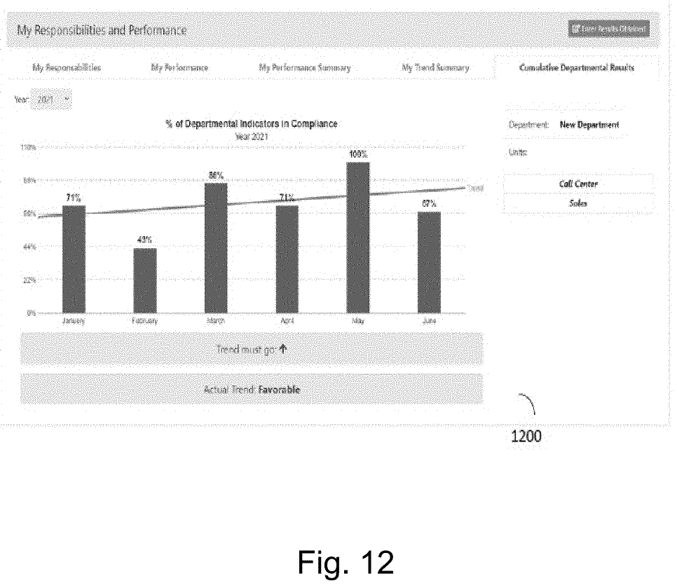

Management using the at least one management computer system with the management application documents the organization's Systemic Performance Indicators. The management can also review the overall performance of the organization or department using screen shown in FIG. 9 responsibility detail, screen shown in FIG. 10 indicator results, screen shown in FIG. 11 result chart and screen shown in FIG. 12 department results.

Management using the at least one management computer system with the management application transfers the organizations mission, the organizations vision, the organizations strategic objectives, the organizations expected behaviors, the organizations Systemic Performance Indicators to the supervisory computer system.

The supervisor computer system transfers the organizations mission, the organizations vision, the organizations Strategic Objectives, the organizations expected behaviors, the organizations Systemic Performance Indicators to at least one employee computer.

The at least at least one employee computer sends the ISP and or Email and or GPS location of the at least at least one employee computer to the supervisory computer system and the supervisory system compares the ISP and or Email and or GPS location of the at least at least one employee computer and determines a known location stored in the supervisor computer system database stores the at least one known location data with the at least one employee data and downloads specific known location information stored in the supervisor computer system in the at least on employee data;

The at least one employee using the at least one employee computer system assembles data which correlates to the Systemic Performance Indicators and using the at least one employee computer with the employee application transfers the data which correlates to the Systemic Performance Indicators to the supervisor computer system and the supervisory computer system stores the data which correlates to the Systemic Performance Indicators to the supervisory computer database.

The at least one employee using the at least one employee computer system provides employee input data for the Systemic Performance Indicators and documents employee input data and the at least one employee computer system stores the employee input data to the Systemic Performance Indicators to the supervisory computer database.

The at least one employee reviews the Systemic Performance Indicators on the supervisory computer database using the at least one employee computer system and analyzes the Systemic Performance Indicators and documents the review of the Systemic Performance Indicators using the at least one employee computer system and stores the Systemic Performance Indicators to the supervisory computer database.

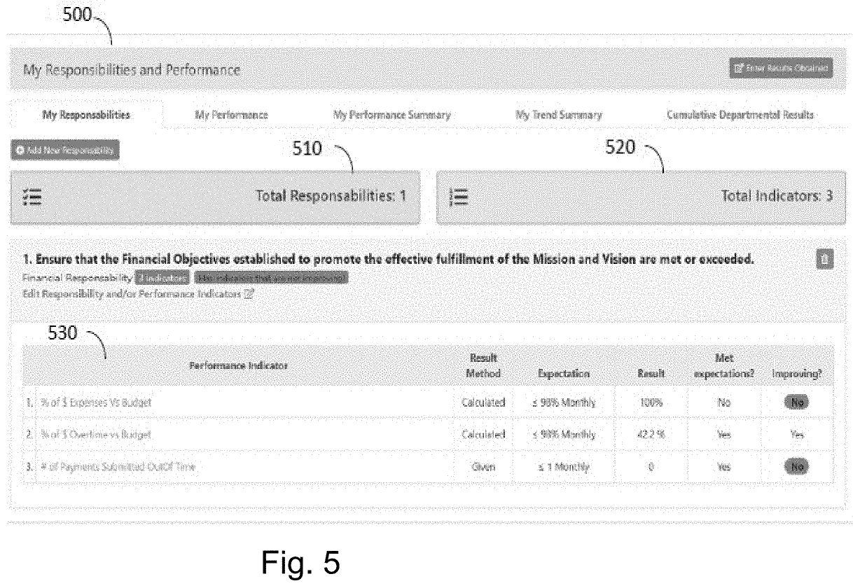

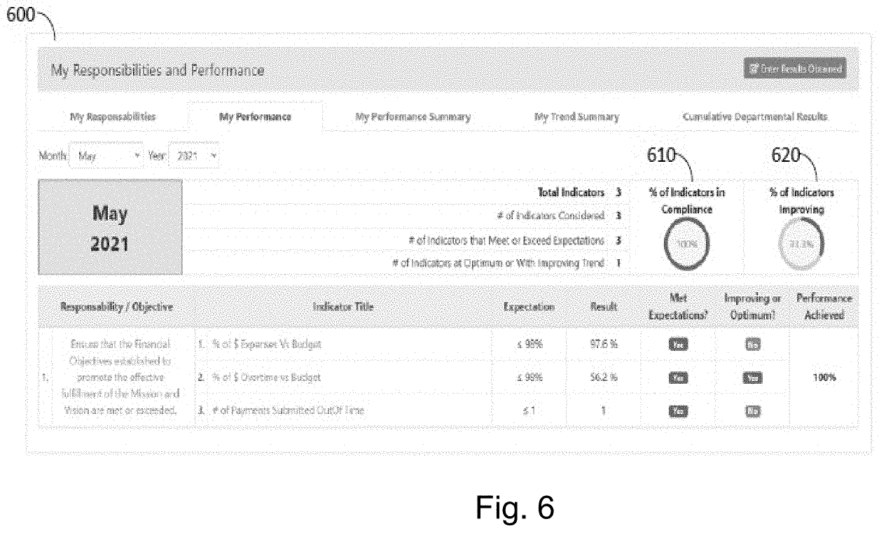

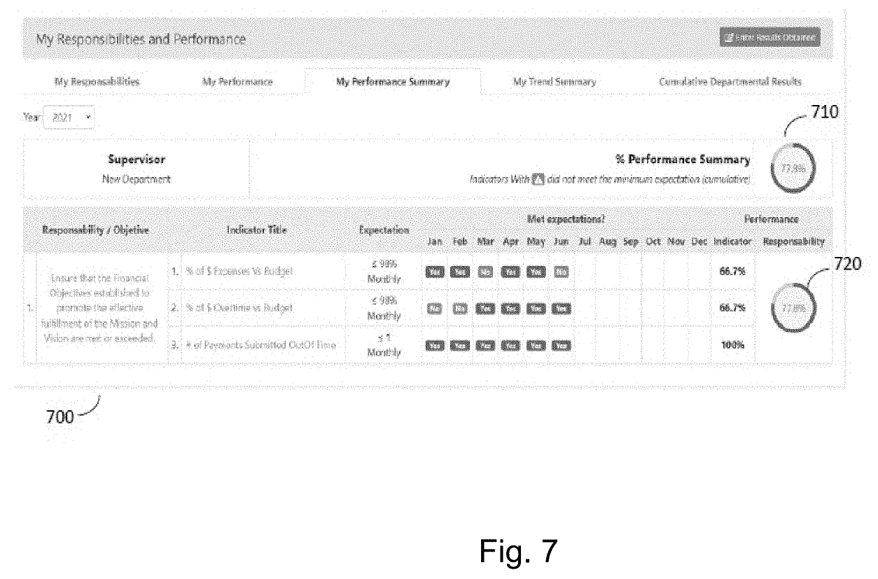

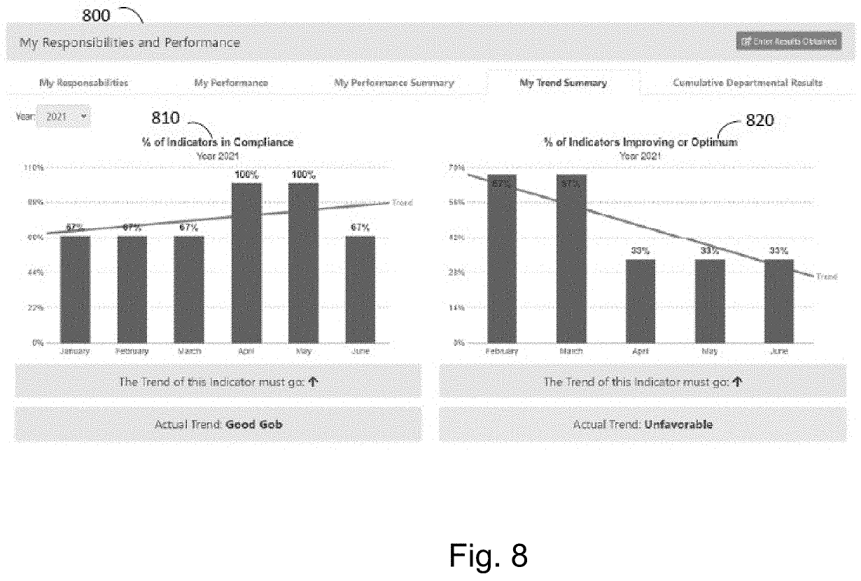

The at least one employee using the at least one employee computer system identifies and documents suggested corrective actions for the Systemic Performance Indicators that are not in compliance with the agreed to the Systemic Performance Indicators; The employee can review information using the at least one employee computer system such as screen shown in FIG. 5 main responsibilities screen 500 which shows total responsibilities 510, total indicators 520 and performance indicators 530, screen shown in FIG. 6 Performance screen 600 which shows percent of indicators in compliance 610 and percent of indicators improving 620, screen shown in FIG. 7 Performance summary screen 700 which shows percent performance summary 710 and responsibility percentage 720; screen shown in FIG. 8 performance trends screen 800 which shows percent indicators in compliance 810 and percent indicators in improving compliance 820; screen shown in FIG. 9 responsibility detail screen 900 which shows performance indicators 910; screen shown in FIG. 10 indicator results 1000, screen shown in FIG. 11 result chart 1100 showing the result performance over time and screen shown in FIG. 12 department results 1200.

The management and the employee using the at least one management computer system with the management application meet at a meeting to review the Systemic Performance Indicators stored in the supervisory computer database. The manager and the employ can look at screen shown in FIG. 9 Department results to see how the employee is doing compared to the overall department.

The management and the employee agreed upon and documented the Systemic Performance Indicators results and corrective actions for the Systemic Performance Indicators at the meeting and using the at least one management computer system with the management application store Systemic Performance Indicators in the supervisory computer database.

The employee and management meet at a next meeting and review the Systemic Performance Indicators results and corrective actions for the Systemic Performance Indicators stored in the supervisory computer database using the management computer.

The management and the employee agreed upon and documented the Systemic Performance Indicators results and agreed upon corrective actions for the Systemic Performance Indicators stored in the supervisory computer database using the management computer at the next meeting.

The supervisory computer uses Artificial Intelligence and Aided Pattern Recognition and to analyze and or experiment with positive and negative pattern correlations between methods and practices with both positive and negative results in order to create knowledge and data trends.

At the next meeting the agreed upon corrective actions from prior review sessions not executed will result in disciplinary actions.

The instant invention using Business Intelligence provides relevant and data-based facts for producing an Organizational Development Plan.

The instant invention using Business Intelligence provides relevant and data-based facts for producing Process Development Plans; and

The instant invention using Business Intelligence provides relevant and data-based facts for producing Individual Development Plans.

The Performance Management Business Method wherein the employee input comprises task performance, quality of output, on time results, new client recruitment, response times and service times.

The Performance Management Business Method wherein the corrective actions are specific to Systemic Performance Indicators.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

As far as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A Performance Management Business Method comprising of the steps:
a. an at least one manager documents an organization's mission.
b. said at least one manager documents an organization's vision.
c. said at least one manager documents an organization's strategic objectives.
d. said at least one manager documents an organization's expected behaviors.
e. said at least one manager documents an organization's Systemic Performance Indicators.
f. said at least one manager conveys said organizations mission, said organizations vision, said organizations Strategic Objectives, said organizations expected behaviors, said organizations Systemic Performance Indicators to an at least one employee.
g. said at least one employee assembles data which correlates to said Systemic Performance Indicators.
h. said at least one employee provides input for said Systemic Performance Indicators and documents said at least one employee input.
i. said at least one employee reviews said Systemic Performance Indicators and analyzes said Systemic Performance Indicators and documents said review of said Systemic Performance Indicators.
j. said at least one employee identifies and documents suggested corrective actions for said Systemic Performance Indicators that are not in compliance with agreed to said Systemic Performance Indicators.
k. said at least one manager and said at least one employee meet at a meeting to review said Systemic Performance Indicators.
l. said at least one manager and said at least one employee agreed upon and documented said Systemic Performance Indicators results and corrective actions for said Systemic Performance Indicators at said meeting.
m. said at least one manager and said at least one employee meet at a next meeting and review said Systemic Performance Indicators results and corrective actions for said Systemic Performance Indicators.
n. said at least one manager and said at least one employee agreed upon and documented said Systemic Performance Indicators results and agreed upon corrective actions for said Systemic Performance Indicators at said next meeting: and
o. at said next meeting said agreed upon corrective actions from prior review sessions not executed will result in disciplinary actions.
p. the instant invention using Business Intelligence provides relevant and result hard data-based facts for producing an Organizational Development Plan.
q. the instant invention using Business Intelligence provides relevant and result hard data-based facts for producing Process Development Plans
r. the instant invention using Business Intelligence provides relevant and result hard data-based facts for producing Individual Development Plans.

2. The Performance Management Business Method of claim 1 wherein the employee input comprises task performance, quality of output, on time results, new client recruitment, response times and service times.

3. The Performance Management Business Method of claim 1 wherein the corrective actions are specific to Systemic Performance Indicators.

4. A Performance Management Business Method that is performed using a supervisory computer system comprising of the steps:
a. said supervisory computer system being connected to at least one management computer with said management application and at least one employee computer with said employee application.
b. said supervisory computer having at least one known location associated with an ISP and or Email and or GPS location and said supervisory computer having a supervisory computer database that stores at least one known location data at least one manager data and at least one employee data.
c. said at least one management computer having a management ISP and or Email and or GPS module and at least one employee computer having an employee ISP and or Email and or GPS module.
d. said at least one management computer sends said ISP and or Email and or GPS location of said at least one management computer to said supervisory computer system and said supervisory computer system said ISP and or Email and or GPS location of said at least one management computer to determine at least one known location and said supervisory computer database stores said at least one known location data with said at least one manager data
e. management using said at least one management computer system with said management application documents an organization's mission on said at least one management computer system.
f. management using said at least one management computer system with said management application documents the organization's vision.
g. management using said at least one management computer system with said management application documents the organization's strategic objectives.
h. management using said at least one management computer system with said management application documents the organization's expected behaviors.
i. management using said at least one management computer system with said management application documents the organization's Systemic Performance Indicators.
j. management using said at least one management computer system with said management application transfers said organizations mission, said organizations vision, said organizations strategic objectives, said organizations expected behaviors, said organizations Systemic Performance Indicators to said supervisory computer system.
k. said supervisor computer system transfers said organizations mission, said organizations vision, said organizations Strategic Objectives, said organizations expected behaviors, said organizations Systemic Performance Indicators to at least one employee computer.
l. said at least at least one employee computer sends said ISP and or Email and or GPS location of said at least at least one employee computer to said supervisory computer system and said supervisory system compares said ISP and or Email and or GPS location of said at least at least one employee computer and determines a known location stored in said supervisor computer system database stores said at least one known location data with said at least one employee data and downloads specific known location information stored in said supervisor computer system in said at least on employee data;
m. said at least one employee using said at least one employee computer system assembles data which correlates to said Systemic Performance Indicators and using said at least one employee computer with said employee application transfers said data which correlates to said Systemic Performance Indicators to said supervisor computer system and said supervisory computer system stores said data which correlates to said Systemic Performance Indicators to said supervisory computer database.
n. said at least one employee using said at least one employee computer system provides employee input data for said Systemic Performance Indicators and documents employee input data and said at least one employee computer system stores said employee input data to said Systemic Performance Indicators to said supervisory computer database.
o. said at least one employee reviews said Systemic Performance Indicators on said supervisory computer database using said at least one employee computer system and analyzes said Systemic Performance Indicators and documents said review of said Systemic Performance Indicators using said at least one employee computer system and stores said Systemic Performance Indicators to said supervisory computer database.
p. said at least one employee using said at least one employee computer system identifies and documents suggested corrective actions for said Systemic Performance Indicators that are not in compliance with said agreed to said Systemic Performance Indicators.
q. said management and said employee using said at least one management computer system with said management application meet at a meeting to review said Systemic Performance Indicators stored in said supervisory computer database.
r. said management and said employee agreed upon and documented said Systemic Performance Indicators results and corrective actions for said Systemic Performance Indicators at said meeting and using said at least one management computer system with said management application store Systemic Performance Indicators in said supervisory computer database.
s. said employee and management meet at a next meeting and review said Systemic Performance Indicators results and corrective actions for said Systemic Performance Indicators stored in said supervisory computer database using said management computer.
t. said management and said employee agreed upon and documented said Systemic Performance Indicators results and agreed upon corrective actions for said Systemic Performance Indicators stored in said supervisory computer database using said management computer at said next meeting.
u. said supervisory computer uses Artificial Intelligence and Aided Pattern Recognition and to analyze and or experiment with positive and negative pattern correlations between methods and practices with both positive and negative results to create knowledge and data trends; and
v. at said next meeting said agreed upon corrective actions from prior review sessions not executed will result in disciplinary actions.
w. said supervisory computer the instant invention using Business Intelligence provides relevant and result hard data-based facts for producing an Organizational Development Plan
x. said supervisory computer the instant invention using Business Intelligence provides relevant and result hard data-based facts for producing Process Development Plans
y. said supervisory computer the instant invention using Business Intelligence provides relevant and result hard data-based facts for producing Individual Development Plans.

5. The Performance Management Business Method of claim 4 wherein the employee input comprises task performance, quality of output, on time results, new client recruitment, response times and service times.

6. The Performance Management Business Method of claim 4 wherein the corrective actions are specific to Systemic Performance Indicators.
